(19) United States
(12) Patent Application Publication
(10) Pub. No.: US 2016/0283895 A1
(43) Pub. Date: Sep. 29, 2016

(54) PLAN DETERMINATION METHOD, COMPUTER-READABLE RECORDING MEDIUM STORING PLAN DETERMINATION PROGRAM, AND PLAN DETERMINATION APPARATUS

(71) Applicant: FUJITSU LIMITED, Kawasaki-shi (JP)

(72) Inventors: YUHEI UMEDA, Kawasaki (JP); Yoshinobu Matsui, Kawasaki (JP); Kazuhiro Matsumoto, Kawasaki (JP); Hirokazu Anai, Hachioji (JP); Isamu Watanabe, Kawasaki (JP)

(73) Assignee: FUJITSU LIMITED, Kawasaki-shi (JP)

(21) Appl. No.: 15/047,042

(22) Filed: Feb. 18, 2016

(30) Foreign Application Priority Data
Mar. 23, 2015 (JP) 2015-059907

(51) Int. Cl. G06Q 10/08

(52) U.S. Cl. CPC G06Q 10/083

(57) ABSTRACT

A plan determination method of which process is executed by a computer, the process includes receiving lead time for each raw material for a product, the lead time being indicative of time interval between a time at which an order of the each raw material is ordered and a time of arrival of the each raw material; and calculating an order quantity of the each raw material and a production quantity of the product which cause a cost relating to manufacturing of the product to be minimized, by using the received lead time for the each raw material and a predicted demand quantity of the product.

### CROSS-REFERENCE TO RELATED APPLICATION

This application is based upon and dams the benefit of priority of the prior Japanese Patent Application No. 2015-059907, filed on Mar. 23, 2015, the entire contents of which are incorporated herein by reference.

### FIELD

The embodiments discussed herein are related to a plan determination method, a computer-readable recording medium storing a plan determination program, and a plan determination apparatus.

### BACKGROUND

For example, there is a technology for determining a shipment plan for a product so as to obtain a high profit, in the manufacturing industry in which a product is produced. In this technology, for example, the quantity of products to be shipped and the price thereof are determined so as to increase profits, in consideration of expenses for procuring raw materials of the products.

An example of the related art is Japanese Laid-open Patent Publication No. 2007-249440.

### SUMMARY

According to an aspect of the invention, a plan determination method of which process is executed by a computer, the process includes receiving lead time for each raw material for a product, the lead time being indicative of time interval between a time at which an order of the each raw material is ordered and a time of arrival of the each raw material; and calculating an order quantity of the each raw material and a production quantity of the product which cause a cost relating to manufacturing of the product to be minimized, by using the received lead time for the each raw material and a predicted demand quantity of the product.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration;

FIG. 2 is a diagram illustrating production and distribution of products;

FIG. 3 is a diagram illustrating the entire configuration of a plan determination apparatus;

FIG. 4 is a diagram illustrating an example of product information;

FIG. 5 is a diagram illustrating an example of demand record information;

FIG. 6 is a diagram illustrating an example of demand prediction information;

FIG. 7 is a diagram illustrating an example of a production cost;

FIG. 8 is a diagram illustrating a predicted demand quantity of a target product for a prediction period, an incoming quantity of each raw material, a production quantity of the target product, a stock quantity of each raw material, and a stock quantity of the target product;

FIG. 9 is a diagram illustrating an example of a storage area for storing the stock quantity of the target product for each number of days passed;

FIG. 10 is a diagram illustrating a flow of plan determination in a factory using the plan determination apparatus;

FIG. 11 is a flowchart illustrating an example of procedures of plan determination processing; and

FIG. 12 is a diagram illustrating a computer which executes a plan determination program.

### DESCRIPTION OF EMBODIMENTS

However, in the related art, there is a case in which it is difficult to decide a way to order raw materials of products and a way to produce the products desired for an increase of profits.

A product may be produced from a plurality of raw materials. It takes a period of time from ordering each of the raw materials until the arrival of the ordered raw material. The period of time from ordering each of the raw materials until the arrival of the ordered raw material may be referred to as “lead time”. The lead time may vary depending on each of the raw materials. Thus, for example, when lead time of a certain raw material is long, the raw material may be insufficient at a timing of producing a product, and producing of the planned number of products may be difficult. Thus, a chance for sales may be lost and profits may be reduced. For example, in the manufacturing industry, a preferable range of a production quantity of products is present due to constraints of productive facilities, working service shifts of workers who are in charge of production, and the like. When the production quantity for products is outside of the preferable range, the cost of producing the products is increased.

Accordingly, it is desired to provide a plan determination method, a computer-readable recording medium storing a plan determination program, and a plan determination apparatus capable of determining an order quantity of each raw material and a production quantity of a product so as to obtain high profits.

Hereinafter, embodiments of a plan determination method, a computer-readable recording medium storing a plan determination program, and a plan determination apparatus will be described in detail with reference to the accompanying drawings. The disclosed technology is not limited to the embodiments. The embodiments may be appropriately combined in a range without processing details in the embodiments being contradictory to each other.

### Embodiment 1

System Configuration

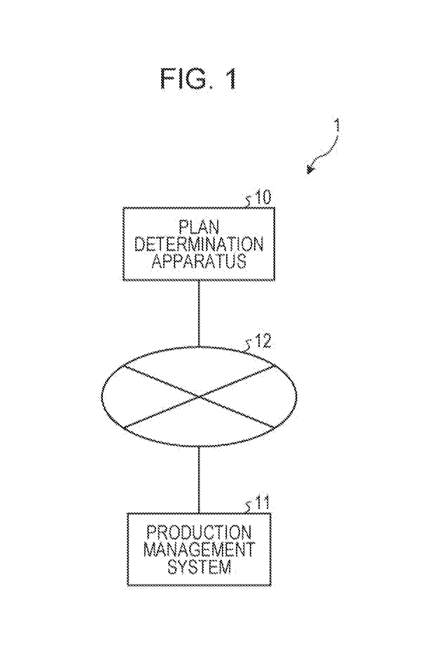

Firstly, an example of a system that performs ordering by using a plan determination apparatus according to Embodiment 1 will be described. FIG. 1 is a diagram illustrating an example of a system configuration. As illustrated in FIG. 1, a system 1 includes a plan determination apparatus 10 and a production management system 11. The plan determination apparatus 10 and the production management system 11 are connected to each other through a network 12 so as to enable communication with each other, and thus may exchange various types of information with each other. As a form of the network 12, various types of communication networks such as mobile communication for a portable phone and the like, the Internet, a local area network (LAN), and a virtual private network (VPN) may be employed regardless of a wired or wireless network.

The production management system 11 is a system for managing production of a product. For example, the production management system 11 is a system which is operated over one server computer or a plurality of server computers. The production management system 11 manages ordering and order receiving of a product or a raw material for the product, or manages a stock quantity in the manufacturing industry in which a product is produced in a factory.

The plan determination apparatus 10 is an apparatus that assists determination of a production plan for producing a product or determination of an ordering plan for ordering a raw material for a product. For example, the plan determination apparatus 10 determines an order quantity of each raw material and a production quantity of a product for a predetermined prediction period, from a predicted demand quantity of a product for the prediction period. And then, the plan determination apparatus 10 outputs the production plan and the ordering plan based on the determined order quantity and the determined production quantity. In this embodiment, a case will be described in which one ordering cycle is set as one period and a prediction period is set to five periods. For example, when the ordering cycle is one day, the prediction period is five days. The plan determination apparatus 10 corresponds to a computer and the like such as a personal computer and a server computer. One computer or a plurality of computers may be mounted for the plan determination apparatus 10. In this embodiment, descriptions will be made by using a case of using one computer for the plan determination apparatus 10 as an example.

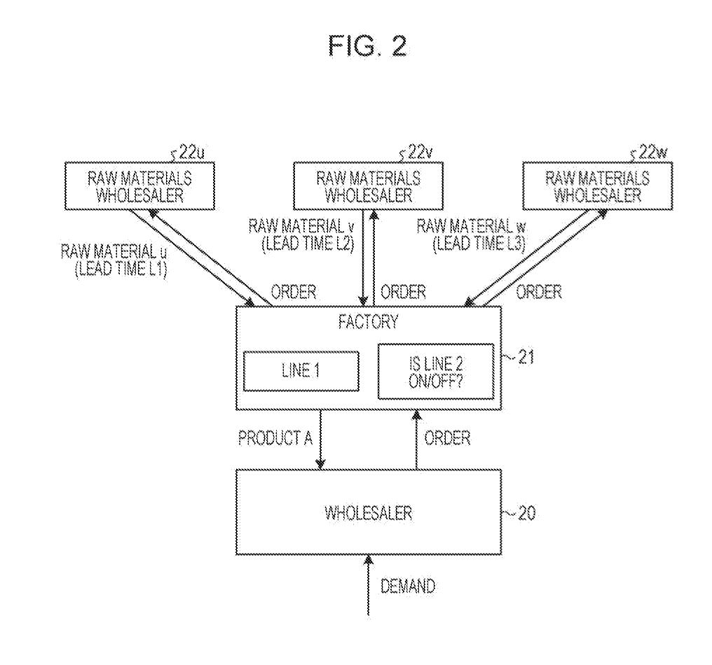

Here, a product according to this embodiment will be described. FIG. 2 is a diagram illustrating production and distribution of a product. In the example of FIG. 2, production and distribution of a product A are illustrated. A wholesaler 20 is a distribution dealer who handles the product A. The wholesaler 20 orders the product A to a factory 21 in accordance with a demand. The factory 21 produces the product A. The factory 21 receives an order for the product A from the wholesaler 20 and delivers the product A having an order quantity which has been ordered. The factory 21 has a line 1 as a production line for producing the product A. The factory 21 may build an additional production line for producing the product A. The factory 21 may additionally build a line 2 depending on a production quantity of the product A. In the factory 21, the product A is produced by using three raw materials u, v, and w. The raw material u is purchased from a raw material wholesaler 22u, the raw material v is purchased from a raw material wholesaler 22v, and the raw material w is purchased from a raw material wholesaler 22w by the factory 21. The raw material wholesaler 22u receives an order for the raw material u from the factory 21 and ships the raw material u having the order quantity with lead time L1. The raw material wholesaler 22v receives an order for the raw material v from the factory 21 and ships the raw material v having the order quantity with lead time L2. The raw material wholesaler 22w receives an order for the raw material w from the factory 21 and ships the raw material w having the order quantity with lead time L3.

The production management system 11 according to this embodiment manages ordering or order receiving for the product A or the raw materials u, v, and w or manages a stock quantity of the product A or the raw materials u, v, and w in the factory 21 in which the product A is manufactured. For example, the production management system 11 manages the stock quantity of the product A based on a shipping quantity of the product A to the wholesaler 20, the production quantity of the product A in the production line, and the like. The production management system 11 manages stock quantities of the raw materials u, v, and w based on consumed quantities of the raw materials u, v, and w which are used in production of the product A in the production line, and incoming quantities of the raw materials u, v, and w from the raw material wholesalers 22u, 22v, and 22w.

The plan determination apparatus 10 according to this embodiment assists determination of a production plan for producing the product A or an ordering plan for ordering the raw materials u, v, and w.

Configuration of Plan Determination Apparatus

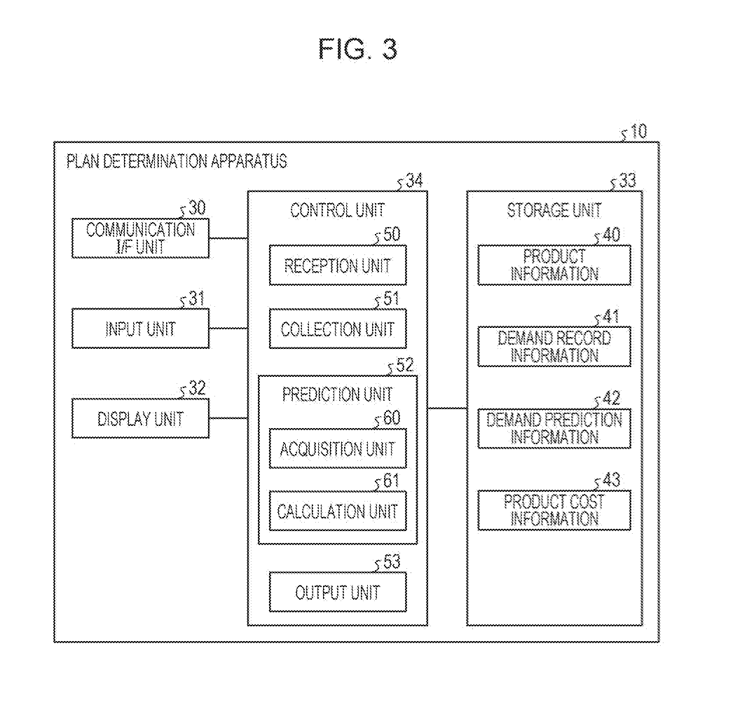

Next, the plan determination apparatus 10 according to Embodiment 1 will be described. FIG. 3 is a diagram illustrating the entire configuration of the plan determination apparatus. As illustrated in the example of FIG. 3, the plan determination apparatus 10 includes a communication I/F (interface) unit 30, an input unit 31, a display unit 32, a storage unit 33, and a control unit 34. The plan determination apparatus 10 may include other units in addition to the above units.

The communication I/F unit 30 is an interface for controlling communication with other devices. As the communication I/F unit 30, a network interface card such as a LAN card may be employed.

The communication I/F unit 30 performs communication of various types of information with other devices through the network 12. For example, the communication I/F unit 30 may perform communication of various types of information with the production management system 11. The communication I/F unit 30 may perform communication of various types of information regarding a target product for which a plan is calculated, with the production management system 11.

The input unit 31 is an input device for inputting various types of information. An example of the input unit 31 includes an input device that receives an input of an operation, such as a mouse and a keyboard. The input unit 31 receives an input of various types of information. For example, the input unit 31 receives an input of various operations relating to determination of a production plan for a target product and an ordering plan of a raw material for the target product. The input unit 31 receives an operation input from a user and inputs operation information indicating the content of the received operation to the control unit 34.

The display unit 32 is a display device for displaying various types of information. An example of the display unit 32 includes a display device such as a liquid crystal display (LCD) and a cathode ray tube (CRT). The display unit 32 displays various types of information. For example, the display unit 32 displays various screens such as a product designation screen, a lead time designation screen, and a plan display screen. The product designation screen is used for designating a target product for which a plan is calculated. The lead time designation screen is used for designating lead time from ordering a raw material until the arrival of the raw material for each of the raw materials of a target product. The plan display screen is used for displaying the order quantity of each of the raw materials and the production quantity of the product.

The storage unit 33 is a storage device such as a hard disk, a solid state drive (SSD), or an optical disk. The storage unit 33 may be a semiconductor memory in which data may be rewritten, such as a random access memory (RAM), a flash memory, or a non-volatile static random access memory (NVSRAM).

The storage unit 33 stores an operating system (OS) or various programs executed by the control unit 34. For example, the storage unit 33 stores various programs used in determination of the ordering plan. The storage unit 33 stores various types of data used in the program that is executed by the control unit 34. For example, the storage unit 33 stores product information 40, demand record information 41, demand prediction information 42, and a production cost information 43.

The product information 40 is data in which various types of information regarding a target product for which a plan is calculated are stored. In the product information 40, various types of information used in calculation of a cost relating to manufacturing of a product are stored. The various types of information includes the stock quantity of a target product for which a plan is calculated, a raw material for the target product, the stock quantity of the raw material, an order unit price of the raw material, and the like. The various types of information stored in the product information 40 may be appropriately updated. For example, the various types of information stored in the product information 40 may be sequentially updated at each ordering timing.

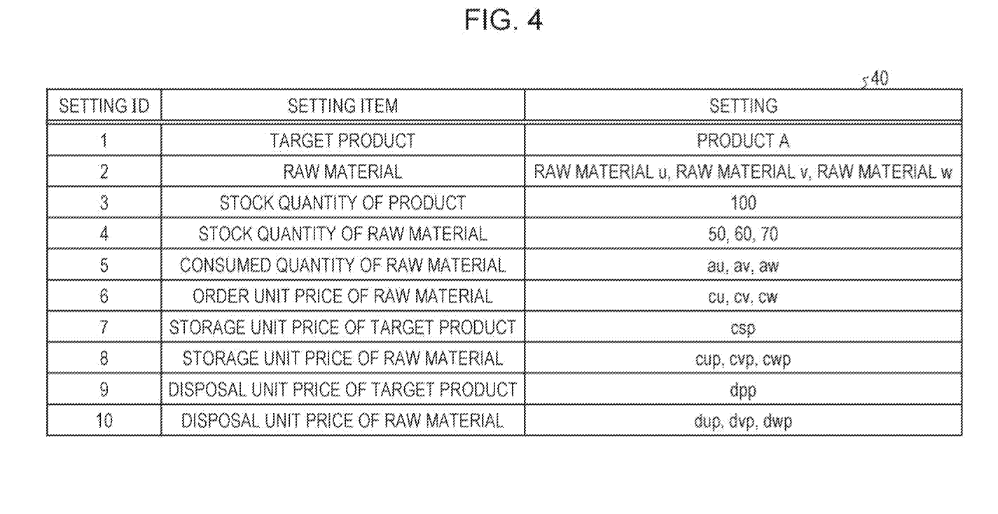

FIG. 4 is a diagram illustrating an example of the product information. The product information 40 includes entries of a setting ID (identification), a setting item, and a setting. The entry of the setting ID is an area in which an identification number for identifying a setting item is stored. Identification numbers for identifying various setting items are respectively assigned to the various setting items. In the entry of the setting ID, the identification number corresponding to the setting item is stored. The entry of the setting item is an area in which an item name of the setting item is stored. The entry of the setting is an area in which a setting content relating to the setting item is stored. In the example of FIG. 4, a setting ID “1” is used for setting a target product for which a plan is calculated as a setting item, and “product A” is set as the setting content. A setting ID “2” is used for setting a raw material used in production of the target product as a setting item, and “raw material u, raw material v, and raw material w” is set as the setting content. The setting content of the setting ID “2” indicates that the product A is produced from the raw material u, the raw material v, and the raw material w. A setting ID “3” is used for setting the current stock quantity of the target product as the setting item, and “100” is set as the setting content. A setting ID “4” is used for setting the current stock quantities of the raw materials as the setting item, and “50, 60, and 70” is set as the setting content. The setting content of the setting ID “4” indicates that the current stock quantity of the raw material u is “50”, the current stock quantity of the raw material v is “60”, and the current stock quantity of the raw material w is “70”. A setting ID “5” is used for setting consumed quantities of the raw materials used when one target product is produced, as the setting item. “au, av, and aw” is set as the setting content for the setting ID “5”. For example, the setting content of the setting ID “5” indicates that the raw material u is consumed as much as “au”, the raw material v is consumed as much as “av”, and the raw material w is consumed as much as “aw” when one product A which is the target product is produced. For example, the “au” is set as “1” if one piece of the raw material u is consumed when one product A is produced.

A setting ID “6” is used for setting order unit prices of the raw materials as the setting item, and “cu, cv, and cw” is set as the setting content. For example, the setting content of the setting ID “6” indicates that the order unit price of the raw material u is “cu”, the order unit price of the raw material v is “cv”, and the order unit price of the raw material w is “cw”. For example, when the order unit price of the raw material u is 100 yen, the “cu” is set as “100”, where yen is Japanese currency unit. A setting ID “7” is used for setting a storage unit price of the target product as the setting item, and “csp” is set as the setting content. For example, the setting content of the setting ID “7” indicates that the storage unit price per one product A is “csp”. For example, when the storage unit price per one product A is 5 yen, the “csp” is set as “5”. A setting ID “8” is used for setting storage unit prices of the raw materials as the setting item. “cup, cvp, and cwp” is set as the setting content. For example, the setting content of the setting ID “8” indicates that the storage unit price per one piece of the raw material u is “cup”, the storage unit price per one piece of the raw material v is “cvp”, and the storage unit price per one piece of the raw material w is “cwp”. For example, when the storage unit price per one piece of the raw material u is 1 yen, the “cup” is set as “1”. A setting ID “9” is used for setting a disposal unit price of the target product as the setting item. “dpp” is set as the setting content. For example, the setting content of the setting ID “9” indicates that the disposal unit price per one product A is the “dpp”. For example, when the disposal unit price per one product A is 5 yen, the “dpp” is set as “5”. A setting ID “10” is used for setting disposal unit prices of the raw materials as the setting item. “dup, dvp, and dwp” is set as the setting content. For example, the setting content of the setting ID “10” indicates that the disposal unit price per one piece of the raw material u is “dup”, the disposal unit price per one piece of the raw material v is “dvp”, and the disposal unit price per one piece of the raw material w is “dwp”. For example, when the disposal unit price per one piece of the raw material u is 5 yen, the “dup” is set as “5”.

Returning to FIG. 3, the demand record information 41 is data in which information regarding the previous demand for the target product for which a plan is calculated is stored. For example, in the demand record information 41, the number of times of receiving of an order or a date of receiving an order for the target product, which has been previously received is stored.

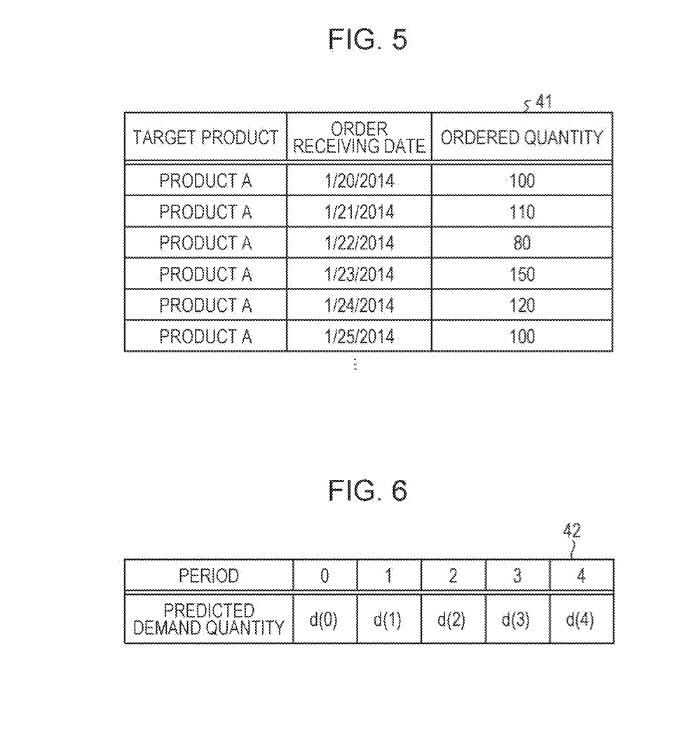

FIG. 5 is a diagram illustrating an example of the demand record information. The demand record information 41 includes entries of a target product, an order receiving date, and an ordered quantity. The entry of the target product is an area in which a target product for which a plan is calculated is stored. The entry of the order receiving date is an area in which the date when an order has been received is stored. The entry of the ordered quantity is an area in which the ordered quantity that has been ordered for the product as a demand quantity is stored. The example of FIG. 5 illustrates that the ordered quantity for the product A is “100” on an order receiving date of “Jan. 20, 2014”.

Returning to FIG. 3, the demand prediction information 42 is data in which a predicted demand quantity of the target product (for which a plan is calculated), which has been predicted during a prediction period is stored. For example, in the demand prediction information 42, the predicted demand quantity of the target product, which has been predicted for the prediction period by a prediction unit 52 (which will be described later) is stored.

FIG. 6 is a diagram illustrating an example of the demand prediction information. In the demand prediction information 42, a period corresponding to the ordering cycle is provided as the prediction period, and the predicted demand quantity for the period is stored. In the example of FIG. 6, periods of “0” to “4” are provided as prediction periods and d(0) to d(4) are stored as the predicted demand quantity. In d(0) to d(4), predicted demand quantities that have been predicted by the prediction unit 52 (which will be described later) are respectively stored.

Returning to FIG. 3, the production cost information 43 is data in which a cost for production of the target product for which a plan is calculated is stored. In this embodiment, as illustrated in FIG. 2, when the product A is produced in the line 1 and the production quantity of the product A exceeds the production upper limit of the line 1, a production line for producing the product A is additionally built and thus production is also performed in the line 2. The production line has a preferable range for the production quantity of a product due to constraints of productive facilities, a shift of a worker who is in charge of production, or the like. When the production quantity of the product is outside of the preferable range, the production cost is increased. Particularly, when the production line is additionally built, the number of the productive facilities or the number of workers who are in charge of production is increased. Thus, the production cost is greatly increased.

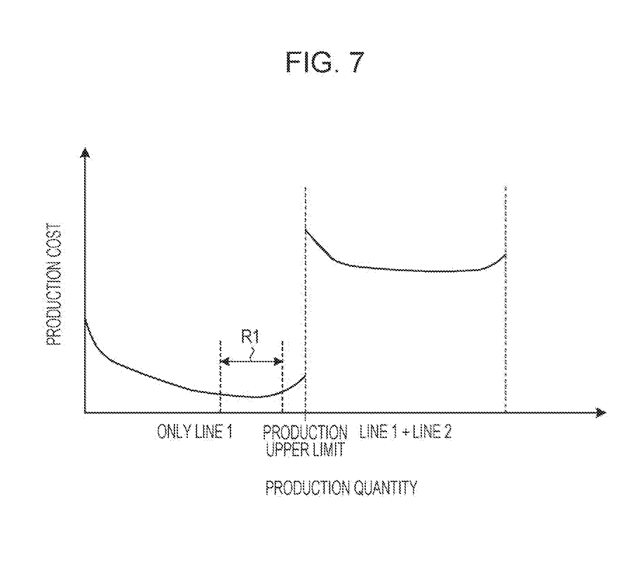

FIG. 7 is a diagram illustrating an example of the production cost. As illustrated in FIG. 7, when only the line 1 is used and the production quantity is in a range R1, the productive facilities or the workers who are in charge of production are used with high efficiency, and an increase of the production cost is suppressed. When the production quantity is reduced from the range R1, an idling period for which the productive facilities or the workers are not used occurs and the production cost is increased. When the production quantity is increased up to the production upper limit from the range R1, the workers are caused to work overtime, for example, extra work. Thus, the production cost is increased. When the production quantity exceeds the production upper limit of the line 1, the number of the productive facilities or the number of workers who are in charge of production is increased and the line 2 is additionally built, and then production is performed. Thus, the production cost is increased.

For example, as illustrated in FIG. 7, in the production cost information 43, the production cost for each production quantity of the product A is stored on the assumption that the production line for producing the product A is additionally built when the production quantity exceeds the production upper limit.

The control unit 34 is a device that controls the plan determination apparatus 10. As the control unit 34, an electronic circuit such as a central processing unit (CPU) and a micro processing unit (MPU), or an integrated circuit such as an application specific integrated circuit (ASIC) and a field programmable gate array (FPGA) may be employed. The control unit 34 includes an internal memory for storing a program which defines various processing procedures, or control data. The control unit 34 performs various types of processing by using the program and the control data. The control unit 34 functions as various processing units by operating various programs. For example, the control unit 34 includes a reception unit 50, a collection unit 51, the prediction unit 52, and an output unit 53.

The reception unit 50 receives an input of various types of information regarding ordering. For example, the reception unit 50 receives designation of a target product for which a plan is calculated. For example, the reception unit 50 displays the product designation screen (not illustrated) so as to receive designation of the target product for which a plan is calculated, from the product designation screen. The reception unit 50 may receive designation of the target product by inputting a code indicating the target product. The reception unit 50 may receive designation of the target product in such a manner that products are classified by categories, the categories are displayed in the display unit 32, and then, products in the selected category are displayed in the display unit 32 so as to cause a product to be selected. The reception unit 50 causes the designated target product to be stored in the product information 40. In this embodiment, the product A is designated as the target product for which a plan is calculated, and thus the product A is stored in the product information 40 as the target product.

The reception unit 50 receives the lead time for each of the raw materials of the product, from ordering the raw material until the arrival of the ordered raw material. For example, the reception unit 50 displays the lead time designation screen (not illustrated) so as to receive the lead time of each of the raw materials, from ordering the raw material until the arrival of the ordered raw material, from the lead time designation screen.

The collection unit 51 performs various collections. For example, the collection unit 51 collects various types of information regarding the target product which is designated by the reception unit 50. For example, the collection unit 51 collects information regarding raw materials used in production of the target product, the current stock quantity of the target product, the current stock quantity of each of the raw materials, and the consumed quantity of each of the raw materials used when one target product is produced, from the production management system 11. The collection unit 51 collects information regarding the order unit price of each of the raw materials, the storage unit price of the target product, the storage unit price of each of the raw materials, the disposal unit price of the target product, and the disposal unit price of each of the raw materials, from the production management system 11. The collection unit 51 collects information regarding the order quantity of each of the raw materials which have been ordered. The collection unit 51 stores the various collected types of information in the product information 40. For example, the collection unit 51 stores information regarding the raw materials used in production of the target product, the current stock quantity of the target product, the current stock quantity of each of the raw materials, the consumed quantity of each of the raw materials used when one target product is produced, in the product information 40. The collection unit 51 stores the information regarding the order unit price of each of the raw materials, the storage unit price of the target product, the storage unit price of each of the raw materials, the disposal unit price of the target product, and the disposal unit price of each of the raw materials, in the product information 40. The collection unit 51 collects the previous demand quantity of the target product from the production management system 11, and stores the previous demand quantity of the target product in the demand record information 41. In this embodiment, the collection unit 51 collects information from the production management system 11 and stores the collected information in the product information 40 and the demand record information 41, but it is not limited thereto. The product information 40 and the demand record information 41 may be stored by an individual system or an individual manager. An input of some or all of the various types of information in the product information 40 may be received by the reception unit 50. For example, the current stock quantity of the target product and the current stock quantity of each of the raw materials may be collected from the production management system 11. An input of the order unit price of each of the raw materials or various types of unit prices may be received by the reception unit 50.

The prediction unit 52 performs various predictions. For example, the prediction unit 52 predicts an order quantity of each of the raw materials and a production quantity of a target product which cause cost relating to manufacturing of the target product for which a plan is calculated to be minimized. In this embodiment, the prediction unit 52 predicts the order quantity of each of the raw materials u, v, and w and the production quantity of the product A which cause the cost relating to manufacturing of the product A to be minimized. The prediction unit 52 includes an acquisition unit 60 and a calculation unit 61.

The acquisition unit 60 performs various acquisitions. For example, the acquisition unit 60 acquires the predicted demand quantity of the target product during the prediction period. For example, the acquisition unit 60 acquires the predicted demand quantity of the product A by predicting a demand during the prediction period based on the previous ordered quantity of the product A, which is stored in the demand record information 41. For example, the acquisition unit 60 performs time-series analysis by using an autoregressive integrated moving average model (ARIMA model) so as to predict the demand of the product A. A method for predicting the demand is not limited thereto, and may be any method. For example, the acquisition unit 60 may learn the previous demands by using a support vector machine and the like, and thus may predict the demand quantity. The acquisition unit 60 may use an ordered quantity (which is stored in the demand record information 41) during the previous period which has the number of days the same as that of the prediction period, as the demand during the prediction period. In this embodiment, a case where the acquisition unit 60 predicts the demand is described. However, it is not limited thereto. For example, a result obtained by predicting a demand of the target product during the prediction period may have been pre-stored as predicted demand information in the storage unit 33, and the acquisition unit 60 may acquire the predicted demand quantity of the target product from the predicted demand information. Other information processing apparatuses may predict the demand of the target product during the prediction period. The acquisition unit 60 may acquire a prediction result from the other apparatuses.

The calculation unit 61 performs various calculations. For example, the calculation unit 61 calculates the order quantity of each of the raw materials and the production quantity of the target product which cause the cost relating to manufacturing of the target product to be minimized, by using the lead time of each of the raw materials which is received by the reception unit 50, and using the predicted demand quantity of the target product which is acquired by the acquisition unit 60. For example, the calculation unit 61 solves an optimization problem of an objective function which uses the order quantity of each of the raw materials and the production quantity of the target product as an input, and uses the cost relating to manufacturing of the target product as an output. Thus, the calculation unit 61 calculates the order quantity of each of the raw materials and the production quantity of the target product which cause the cost to be minimized.

Here, the objective function used in the optimization problem, and constraint conditions will be described. Firstly, parameters used in calculation of the cost relating to manufacturing of the target product will be described.

In this embodiment, the product A which is the target product is produced by using the three raw materials u, v, and w. The raw material u has the lead time Li which is designated as “1”. The raw material v has the lead time L2 which is designated as “2”. The raw material w has the lead time L3 which is designated as “2”. The raw material u may be ordered during any period and an order quantity of the raw material u for a period of k is set as u(k). The raw material v may be ordered during any period and an order quantity of the raw material v for the period of k is set as v(k). The raw material w may be normally ordered for each one day and an order quantity corresponding to normal ordering of the raw material w for the period of k is set as w₁(k). The raw material w may be urgently ordered for a period when normal ordering is difficult. An order quantity corresponding to urgent ordering of the raw material w for, for example, a period of (k+1) when normal ordering is difficult is set as w₂(k+1).

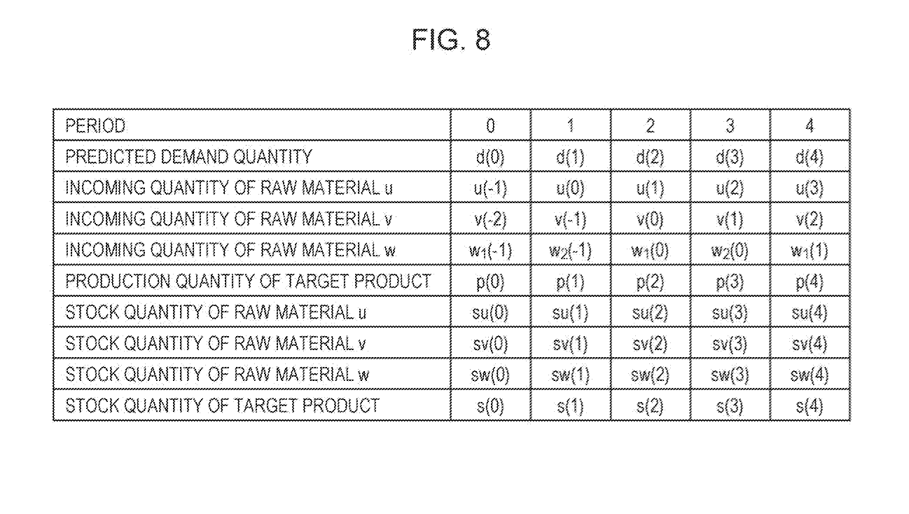

In this embodiment, the prediction period is set to 5 days. In this case, the predicted demand quantity of the product, the incoming quantity of each of the raw materials, the production quantity of the target product, the stock quantity of each of the raw materials, and the stock quantity of the target product, for 5 days which is the prediction period are as illustrated in FIG. 8. FIG. 8 is a diagram illustrating the predicted demand quantity of the target product, the incoming quantity of each of the raw materials, the production quantity of the target product, the stock quantity of each of the raw materials, and the stock quantity of the target product, for the prediction period. In the example of FIG. 8, 5 days which is the prediction period are respectively indicated by periods of 0 to 4.

d(0) to d(4) are the predicted demand quantity of the target product for each of the periods of 0 to 4. d(0) to d(4) are acquired by the acquisition unit 60. In the example of FIG. 8, incoming quantities of the raw material u for the periods of 0 to 4 are set as u(−1) to u(3). Since the raw material u may be ordered every day and the lead time L1 is “1”, delivery is performed after one day from when ordering is performed. Thus, the incoming quantities of the raw material u respectively correspond to order quantities u(−1) to u(3) one day before. In the example of FIG. 8, incoming quantities of the raw material v for the periods of 0 to 4 are set as v(−2) to v(2). Since the raw material v may be ordered every day and the lead time L2 is “2”, delivery is performed after two days from when ordering is performed. Thus, the incoming quantities of the raw material v respectively correspond to order quantities v(−2) to v(2) two days before. In the example of FIG. 8, incoming quantities of the raw material w for the periods of 0 to 4 are set as w₁(−1), w₂(−1), w₁(0), w₂(0), and w₁(1). w₁(−1), w₁(0), and w₁(1) respectively correspond to order quantities by normal ordering before one time, this time, and after one time by using the current point of time as a reference. w₂(−1) and w₂(0) respectively correspond to order quantities by urgent ordering before one time and this time by using the current point of time as a reference. Since normal ordering and urgent ordering for the raw material w may be alternately performed each day, and the lead time L3 is “2”, delivery is performed after two days from when ordering is performed. Normal ordering w₁(−1) before one-time has been performed two days before. Thus, w₁(−1) is stored in the incoming quantity of the raw material w of the period of 0. Urgent ordering w₂(−1) before one-time has been performed one day before. Thus, w₂(−1) is stored in the incoming quantity of the raw material w of the period of 1.

p(0) to p(4) respectively correspond to production quantities of the product A which is the target product, for the periods of 0 to 4. su(0) to su(4) respectively correspond to stock quantities of the raw material u of the periods of 0 to 4. sv(0) to sv(4) respectively correspond to stock quantities of the raw material v of the periods of 0 to 4. sw(0) to sw(4) respectively correspond to stock quantities of the raw material w of the periods of 0 to 4. s(0) to s(4) respectively correspond to stock quantities of the product A (which is the target product) of the periods of 0 to 4.

The stock quantities of the target product of the period of 0 to 4 may be calculated from the following expression (1).

s(k)=s(k−1)+p(k)−d(k) (1)

Here, s(k) indicates the stock quantity of the target product of the period of k. p(k) indicates the production quantity of the target product of the period of k. d(k) indicates the demand quantity of the target product of the period of k.

The expression (1) indicates that the stock quantity of the target product of the period of k is calculated by adding the production quantity of the period of k to the stock quantity of the period of (k−1) which is one period before, and by subtracting the demand quantity of the period of k. s(1) to s(4) may be calculated in this sequence by using s(0) as the current stock quantity of the target product and by using the expression (1).

The predicted stock quantity of the raw materials of the period of k in the prediction period is calculated by adding the incoming quantity of the period of k to the stock quantity of the raw materials of the period of (k−1) which is one period before and by subtracting the consumed quantity of the period of k. For example, the stock quantity of the raw material u of the period of k is calculated from the following expression (2). The raw materials are assumed to be delivered as much as the order quantity after the lead time if ordering is performed. That is, it is assumed that deficiency of the raw materials does not occur.

su(k)=su(k−1)+u(k−L1)−p(k)×au (2)

Here, su(k) indicates the stock quantity of the raw material u of the period of k. u(k−L1) indicates the order quantity of the raw material u of the period of (k−L1) and indicates the incoming quantity of the raw material u of the period of k. L1 indicates the lead time of the raw material u. au indicates the consumed quantity of the raw material u used when one product A is produced.

The expression (2) indicates that the stock quantity of the raw material u of the period of k is calculated by adding an order quantity which has been ordered for the period of (k−L) to the stock quantity of the raw material u of the period of (k−1) which is one period before, and by subtracting the consumed quantity of the raw material u which has been consumed in production of the product for the period of k. su(1) to su(4) may be calculated in this sequence by using su(0) as the current stock quantity of the target product and by using the expression (2).

There occurs various types of costs in production of a product. For example, regarding the raw material, there is an order cost for purchasing the raw material. The order cost is calculated by multiplying the order unit price of the raw material by the incoming quantity of the raw material delivered for the period of k. For example, the order cost for the raw material u is calculated from the following expression (3).

ocu(k)=u(k−L1)×cu (3)

Here, ocu(k) indicates the order cost for the raw material u for the period of k. cu indicates the order unit price of the raw material u.

Similarly, the calculation unit 61 may calculate an order cost ocv(k) for the raw material v for the period of k by multiplying order unit price cv of the raw material v by the incoming quantity of the raw material v delivered for the period of k. The calculation unit 61 may calculate an order cost ocw(k) for the raw material w for the period of k by multiplying order unit price cw of the raw material w by the incoming quantity of the raw material w delivered for the period of k. Regarding the raw material w, the order unit price of the raw material w in the normal ordering is used in a case of the normal ordering, and the order unit price of the raw material w in the urgent ordering is used in a case of the urgent ordering.

When unit ordering in which ordering is performed in a unit of one piece, and lot ordering in which ordering of several pieces is performed may be possible for the raw material, the calculation unit 61 obtains the order cost by adding a value obtained by multiplying the number of times of ordering performed in unit ordering and the order unit price in the unit ordering, and a value obtained by multiplying the number of times of ordering performed in lot ordering and the order unit price in the lot ordering. For example, when the unit ordering in which ordering is performed in a unit of one piece, and the lot ordering in which ordering of several pieces is performed may be able for the raw material u, the order cost of the raw material u of the period of k is calculated from the following expression (4).

ocu(k)=floor(u(k−L)/oru)×cru+rem(u(k−L),oru)×csu (4)

Here, oru indicates the incoming quantity of the raw material u when lot ordering is performed once. For example, when 12 pieces of the raw material u are delivered by the lot ordering once, oru is “12”. cru indicates the order unit price of the raw material u in the lot ordering once. csu indicates the order unit price of the raw material u in the unit ordering once. floor(a/b) indicates computation for obtaining a value of an integer part of a value obtained by dividing a by b. rem(a,b) indicates computation for obtaining a value of the remainder of dividing a by b.

The expression (4) for calculating the order cost is just an example and is determined depending on an ordering unit. The order cost may be calculated by adding additional costs such as a delivery cost. When lot ordering and unit ordering are performed for the raw material, the collection unit 51 collects the order unit price of the raw material in the lot ordering and the order unit price of the raw material in the unit ordering, from the production management system 11 and stores the collected order unit prices in the product information 40.

The order cost f(k) of the period of k is calculated by adding the order cost of the raw materials of the period of k. For example, the order cost f(k) of the raw materials u, v, and w of the period of k is calculated from the following expression (5).

f(k)=ocu(k)+ocv(k)+ocw(k) (5)

For example, there is a storage cost in storing of the raw material or the product in stock. The storage cost for the product is calculated, for example, by multiplying the storage unit price of the product by the stock quantity of the product for each day. For example, the storage cost of the period of k for the target product may be calculated from the following expression (6).

hp(k)=s(k)×csp (6)

Here, hp(k) indicates the storage cost of the period of k for the target product.

csp indicates the storage unit price per one product.

For example, the storage cost of the raw material is calculated by multiplying the storage unit price of the raw material by the stock quantity of the raw material for each day. For example, the storage cost of the period of k for the raw material u may be calculated from the following expression (7).

su(k)=su(k)×cup (7)

Here, su(k) indicates the storage cost of the period of k for the raw material u. cup indicates the storage unit price per one piece of the raw material u.

Similarly, the calculation unit 61 may calculate storage cost sv(k) of the period of k for the raw material v by multiplying the storage unit price cvp of the raw material v by the stock quantity of the raw material v of the period of k. The calculation unit 61 may calculate a storage cost sw(k) of the period of k for the raw material w by multiplying the storage unit price cwp of the raw material w by the stock quantity of the raw material w of the period of k.

A storage cost hm(k) of the period of k for the raw materials is calculated by adding the storage cost of the raw materials of the period of k. For example, the storage cost hm(k) of the period of k for the raw materials u, v, and w is calculated from the following expression (8).

hm(k)=ocu(k)+ocv(k)+ocw(k) (8)

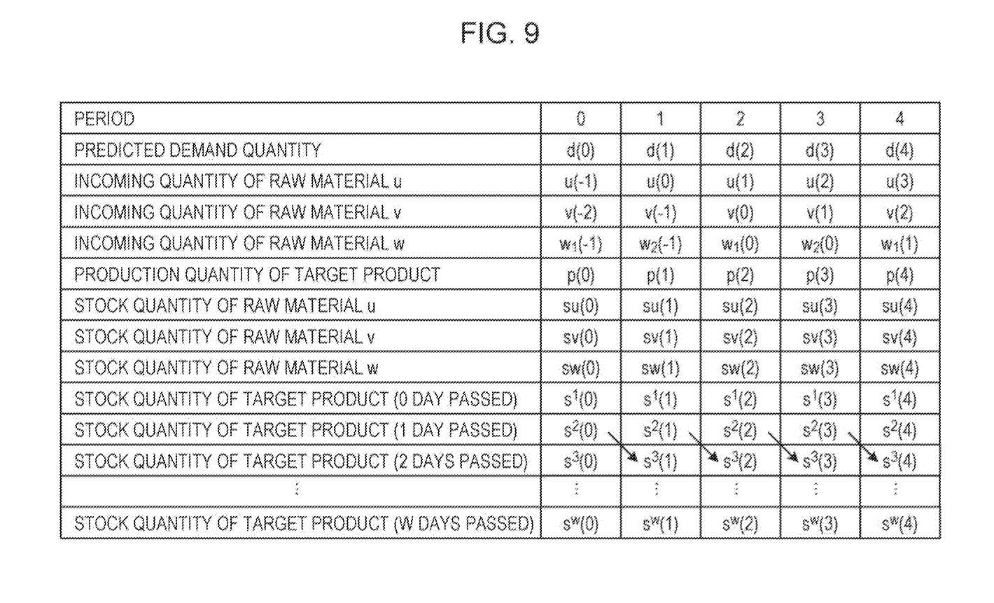

For example, when there is a storing time limit such as a consumption time limit, in the raw material or the product, and the raw material or the product of which the storing time limit has been passed is to be discarded, a disposal cost for this raw material or this product is generated. In this case, the raw material or the product in stock is managed each day from the production date or the incoming date. For example, when the storing time limit of the product is set as w, stocks are managed each number of days passed from the date when production has been performed, regarding each day of the prediction period. For example, as illustrated in FIG. 9, a storage area s¹ in which the stock quantity of the target product for each number of days passed is stored is provided. FIG. 9 is a diagram illustrating an example of the storage area in which the stock quantity of the target product for each number of days passed is stored. The stock quantity of the product is stored as follows, for example.

When there is no demand of the product for the period of k, the calculation unit 61 delays the stock quantity on each day, by one day. For example, when predicted demand quantity d(k)=0, as illustrated in the following expression (9), the calculation unit 61 delays the stock quantity on each day, by one day. The calculation unit 61 stores the stock quantity by production for the period of k as the stock quantity s¹(k) on the first day of the period of k, as illustrated in the following expression (10).

s¹(k)=s^{l-1}(k−1) (l=2 . . . W) (9)

s¹(k)=p(k) (10)

When there is a demand of the product for the period of k, the calculation unit 61 updates the stocks for each production date by shipping products as much as the predicted demand quantity in an order from the product having the old production date within the storing time limit. For example, when the predicted demand quantity d(k) has a positive value, the calculation unit 61 subtracts the predicted demand quantity d(k) from s¹ with reducing of l one-by-one in an order from w, for example, while I is sequentially set to w, w−1, −2 . . . For example, the calculation unit 61 subtracts the predicted demand quantity d(k) from the stocks having storing time which is closest to the storing time limit, as illustrated in the following expression (11).

s^{w}(k)=max(s^{w-1}(k−1)−d(k),0) (11)

Here, max(a,b) indicates computation for obtaining a larger one of a and b.

The expression (11) indicates that products of the predicted demand quantity d(k) may be shipped from s^{w-1}(k−1) when a value of s^{w-1}(k−1)−d(k) is equal to or greater than zero. When s^{w-1}(k−1)−d(k) is less than zero, sw(k) is 0, and thus subtraction of products of the predicted demand quantity d(k) is difficult. Accordingly, the calculation unit 61 subtracts the remaining of subtraction from the stocks on the date of one day before, as illustrated in the following expression (12).

s^{w-1}(k)=max(s^{w-2}(k−1)−max(d(k)−s^{w-1}(k−1),0),0) (12)

When s^{w-2}(k−1)−max(d(k)−s^{w-1}(k−1),0) is less than zero, similarly, the calculation unit 61 subtracts the remaining of subtraction from the stocks on the date of one day before. The calculation unit 61 causes the stock quantity for a period later than the period for which products of the predicted demand quantity d(k) are subtracted from the stocks to be delayed by one day by using the expressions (9) and (10). In this manner, the calculation unit 61 updates stocks for each production date by shipping products of the predicted demand quantity from products which have an old production date within the storing time limit.

In this manner, when the stocks are managed for each number of days passed from the production date, the stock quantity stored in s^{w}(k) corresponds to the stocks having a storing time which will pass a storing time limit tomorrow. Thus, the disposal cost for the product is calculated by multiplying the disposal unit price of the product by the stock quantity having an elapsed storing time. For example, the disposal cost of the period of k for the target product may be calculated from the following expression (13-1).

gp(k)=s^{w}(k)×dpp (13-1)

Here, gp(k) indicates the disposal cost for the target product of the period of k. dpp indicates the disposal unit price per one target product.

When unit disposal in which disposal is performed in a unit of one piece of the target product, and lot disposal in which disposal is performed in a unit of several pieces of the target product may be performed, the disposal cost is calculated from the following expression (13-2).

gp(k)=floor(s^{w}(k)/dru)×cdr+rem(s^{w}(k),dru)×cds (13-2)

Here, dru indicates a product quantity when product is subjected to lot disposal once, cdr indicates the disposal unit price when lot disposal is performed once. cds indicates the disposal unit price when unit disposal is performed once.

The expressions (13-1) and (13-2) for calculating the disposal cost are just examples and are determined depending on a disposal unit. When lot disposal and unit disposal of the target product are performed, the collection unit 51 collects the disposal unit price of the target product in the lot ordering and the disposal unit price of the target product in the unit disposal, from the production management system 11 and stores the collected disposal unit prices in the product information 40.

The disposal cost of each of the raw materials may be calculated by managing stocks for each number of days passed from the incoming date, similarly to a case of the product. For example, when stock quantities of the raw materials u, v, and w of the period of k, which has storing time passing the storing time limit w are respectively set as su^{w}(k), sv^{w}(k), and s^{w}(k), the disposal cost of the raw materials u, v, and w are calculated from the following expressions (14-1) to (14-3).

du(k)=su^{w}(k)×dup (14-1)

dv(k)=sv^{w}(k)×dvp (14-2)

dw(k)=sw^{w}(k)×dwp (14-3)

Here, du(k) indicates the disposal cost of the raw material u of the period of k. dv(k) indicates the disposal cost of the raw material v of the period of k. dw(k) indicates the disposal cost of the raw material w of the period of k. dup indicates the disposal unit price per one piece of the raw material u. dvp indicates the disposal unit price per one piece of the raw material v. dwp indicates the disposal unit price per one piece of the raw material w.

The disposal cost gm(k) of the raw materials of the period of k is calculated by adding the disposal cost of the raw materials of the period of k to each other. For example, the disposal cost gm(k) of the raw materials u, v, and w of the period of k is calculated from the following expression (15).

gm(k)=du(k)+dv(k)+dw(k) (15)

The disposal cost of the raw materials by the unit disposal of one unit and the lot disposal of a unit of several pieces may be obtained.

For example, when a product is produced from each of the raw materials in the production line, a production cost is generated. The production cost pc(k) of the period of k may be obtained from the production quantity p(k) of the target product of the period of k, from the production cost information 43. For example, the calculation unit 61 reads the production cost depending on the production quantity p(k) of the target product of the period of k, from the production cost information 43, and thus obtains the production cost pc(k) of the period of k.

The production cost pc(k) of the period of k may be obtained by multiplying the production quantity by a unit production cost when one target product is produced.

As a result, a cost relating to manufacturing of a product for the periods of 0 to 4, which is the prediction period is represented by, for example, the following expression (16). In the expression (16), the order cost f(k) of the raw materials u, v, and w, the production cost pc(k) of a product, the storage cost hm(k) of the raw materials u, v, and w, the storage cost hp(k) of the product, the disposal cost gm(k) of the raw materials u, v, and w, and the disposal cost gp(k) of the target product for the periods of 0 to 4 are added.

$$cost = {\sum }_{k = 0}^{4} ( f ( k ) + pc ( k ) + hm ( k ) + h p ( k ) + gm ( k ) + gp ( k ) ) \qquad ( 16 )$$

Here, production quantities p(0) to p(4) among the variables illustrated in FIGS. 8 and 9 are changeable parameters. Incoming quantities u(k), v(k), and w(k) of the raw materials which satisfy k≧0 are changeable parameters because of being delivered by ordering in the future. Incoming quantities u(k), v(k), and w(k) of the raw materials which satisfy k<0 are unchangeable parameters because of having been ordered already. The stock quantities of the target product and the raw materials are changed depending on the production quantity of the product and the incoming quantities of the raw materials. Thus, the order cost f(k) of each of the raw materials u, v, and w, the production cost pc(k) of the product, the storage cost hm(k) of each of the raw materials u, v, and w which are described above are changed depending on the production quantity of the product and the incoming quantities of the raw materials. The storage cost hp(k) of the product, the disposal cost gm(k) of each of the raw materials u, v, and w, and the disposal cost gp(k) of the target product are also changed depending on the production quantity of the product and the incoming quantities of the raw materials. That is, the expression (16) is a function which uses the order quantity of each of the raw materials and the production quantity of the product as an input, and uses the cost relating to manufacturing of the product as an output.

The calculation unit 61 calculates the order quantity of each of the raw materials and the production quantity of the product which cause the cost to be minimized, by using the expression (16) as an objective function. In the calculation, the calculation unit 61 may calculate the order quantity of each of the raw materials and the production quantity of the product under various constraint conditions.

For example, because occurrence of deficiency in which the product is out of stock causes loss of an opportunity, the occurrence of deficiency is preferably avoided. In order to avoid the occurrence of the deficiency, the stock quantity on each day of the prediction period may be equal to or greater than the demand on the corresponding day. For example, the stock quantity s(k) of the target product for the prediction period being equal to or greater than zero as in the following expression (17) is set as a condition.

s(k)≧0 (k=0 to 4) (17)

The calculation unit 61 sets various types of information acquired by the acquisition unit 60 and solves the optimization problem of the objective function represented by the expression (16) under the various constraint conditions, and thereby calculates the order quantity of each of the raw materials and the production quantity of the product which cause the cost to be minimized. For example, the calculation unit 61 sets the various types of information which have been acquired by the acquisition unit 60 and stored in the product information 40. The calculation unit 61 sets the ordering quantity which has been already ordered, corresponding to the incoming quantities u(k), v(k), and w(k) of the raw materials which satisfy k<0. The calculation unit 61 solves the optimization problem of the objective function by using a limit of the stock quantity represented by the expression (17) described above as the constraint condition and calculates the order quantities of the raw materials and the production quantity of the product which cause the cost to be minimized. For example, the calculation unit 61 repeats calculation of the cost by changing the values of the production quantities p(0) to p(4) and the incoming quantities u(k), v(k), and w(k) which satisfy k≧0 to be smaller and lager than predetermined initial values thereof. The calculation unit 61 obtains the order quantity of each of the raw materials and the production quantity of the product such that the calculated cost becomes minimal and does not to decrease any more.

so that the calculated cost becomes minimal is turned to to be calculated

The function for the cost relating to manufacturing of the product, which is represented by the expression (16) is just an example. The function for the cost may be configured only by some of the order cost f(k) of the raw materials, the production cost pc(k) of the product, the storage cost hm(k) of the raw materials, the storage cost hp(k) of the product, the disposal cost gm(k) of the raw materials u, v, and w, and the disposal cost gp(k) of the target product. The function for the cost may be configured by adding other cost. The constraint conditions are not limited to the above-described conditions, and various conditions may be used as the constraint conditions.

For example, the calculation unit 61 may calculate a cost which includes a deficient product cost due to a penalty depending on deficiency of the product, without addition of the constraint conditions of the expression (17) which are used for avoiding the occurrence of deficiency. For example, the calculation unit 61 calculates a deficient product quantity generated due to that the stock quantity of the product which is calculated based on the production quantity of the product and the predicted demand quantity of the product does not satisfy the next predicted demand quantity of the product. For example, the calculation unit 61 obtains the deficient product quantity of the period of k from the following expression (18), based on a result obtained by calculating the stocks.

loss(k)=min(0,s(k)) (18)

Here, loss(k) indicates the deficient product quantity of the target product during the period of k. min(a,b) is computation for obtaining smaller one of a and b.

When the stock quantity of the product does not satisfy the next predicted demand quantity of the product, the stock quantity s(k) of the target product has a negative value and the negative value is stored in loss(k).

The deficient product cost is calculated by, for example, the function of Ic(loss(k)) which has loss(k) as a parameter. Ic(loss(k)) may be variously determined in accordance with an influence by deficiency. For example, when degradation of reliability for a delivery destination with deficiency becoming larger is set as the deficient product cost, Ic(loss(k)) may use an exponential function or a quadric function of which the value is increased as the value of loss(k) is negative and becomes smaller. For example, there is a case where the reliability for the delivery destination of the product is degraded in accordance with the deficient product quantity until the deficiency reaches a predetermined quantity, but the product is considered as a product having many demands and occurrence of the degradation may be reduced when the deficiency exceeds the predetermined quantity. In this case, a function for Ic(loss(k)) may be adopted in which the value of the function decreases according to decrease of value of loss(k) to a negative predetermined value, but the value of the function converges when the value of loss(k) is equal to or smaller than the negative predetermined value.

For example, the cost relating to manufacturing may include deficient product cost Ic(loss(k)) as represented by the following expression (19).

$$cost = {\sum }_{k = 0}^{4} ( f ( k ) + pc ( k ) + hm ( k ) + h p ( k ) + gm ( k ) + gp ( k ) + lc ( loss ( k ) ) ) \qquad ( 19 )$$

Thus, when the cost is degreased, the calculation unit 61 may obtain a plan in which occurrence of deficiency of the product is intended.

In this embodiment, the normal ordering and the urgent ordering may be performed for the raw material w. When a plan in which the urgent ordering is not permitted is obtained, w₂(k)=0 (k≧0) is set for the order quantity in the urgent ordering and the calculation unit 61 solves the optimization problem, and thus may obtain a plan in which the urgent ordering is not performed. When the urgent ordering is allowable, the order unit price in the urgent ordering is set to be greater than that in the normal ordering, and the calculation unit 61 solves the optimization problem. Thus, the calculation unit 61 may obtain a plan in which the urgent ordering is allowable. In this case, the order unit price in the normal ordering and the order unit price in the urgent ordering are stored from the production management system 11 in the product information 40.

The output unit 53 performs various types of outputs. For example, the output unit 53 outputs the plan display screen on which the order quantity of each of the raw materials and the production quantity of the product which are calculated by the calculation unit 61 are displayed, to the display unit 32. The output unit 53 may output the order quantity of each of the raw materials as an ordering plan to the production management system 11, and thus automatic ordering may be performed. The output unit 53 may output the production quantity of the product as a production plan of the product to the production management system 11, and thus automatic production management may be performed.

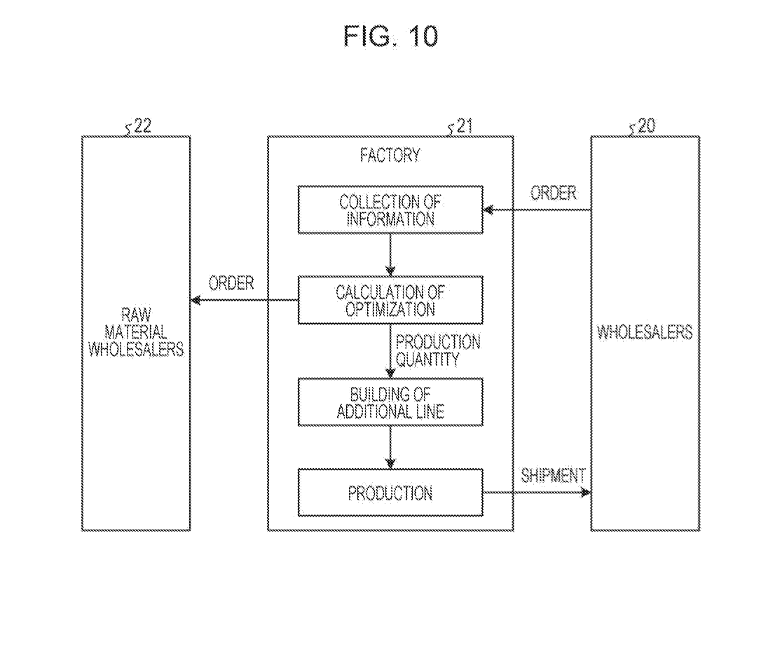

Next, a flow of plan determination in a factory using the plan determination apparatus 10 will be described. FIG. 10 is a diagram illustrating the flow of plan determination in a factory using the plan determination apparatus.

The factory 21 receives an order of the product A from the wholesaler 20. In the factory 21, a production plan for the product A and an ordering plan for each of the raw materials of the product A are obtained by using the plan determination apparatus 10. For example, in the factory 21, various types of information regarding the product A are collected by the plan determination apparatus 10. In the plan determination apparatus 10, a demand for the prediction period is predicted and thus a predicted demand quantity of the product A is acquired. In the plan determination apparatus 10, lead time from ordering the raw material until the arrival of the raw material is received. The plan determination apparatus 10 solves the optimization problem of the objective function by using the lead time for each of the raw materials and the predicted demand quantity of the product, and thus calculates an order quantity of each of the raw materials and a production quantity of the product which cause the cost to be minimized. In the factory 21, the order quantity calculated by the plan determination apparatus 10 is ordered to the raw material wholesaler 22 of the raw material. In the factory 21, an additional production line is built depending on the calculated production quantity. The factory 21 produces the product A in accordance with the calculated production quantity and ships the produced product A to the wholesaler 20.

In this manner, ordering in accordance with an order quantity of each of the raw materials, which is calculated by the plan determination apparatus 10 is performed, and, in the factory 21, ordering of a plurality of raw materials which have different lead time or different ordering timings may be appropriately performed. The plan determination apparatus 10 may perform an instruction of the optimum production quantity depending on a cost of the raw material of a manufacturing line. The plan determination apparatus 10 includes the constraint conditions represented by the above-described expression (17) or the deficient product cost in the cost, and thus it is possible to reduce a risk in the deficiency of the product A occurred in the factory 21. The plan determination apparatus 10 may assist determination regarding building of an additional manufacturing line of the factory 21.

Flow of Processing

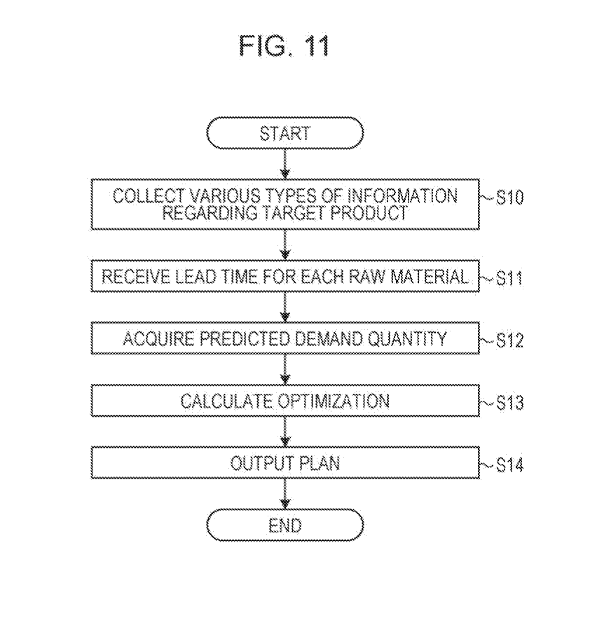

Next, a flow of plan determination processing of causing the plan determination apparatus 10 to determine a plan will be described. FIG. 11 is a flowchart illustrating an example of procedures of the plan determination processing. The plan determination processing is performed at a predetermined timing, for example, at a timing when a designation of the target product for which a plan is calculated is received by the reception unit 50.

As illustrated in FIG. 11, the collection unit 51 collects various types of information regarding the target product and stores the collected information in the storage unit 33 (S10). For example, the collection unit 51 collects information regarding the raw materials which are used in production of the target product, the current stock quantity of the target product, the current stock quantity of each of the raw materials, and the consumed quantity of each of the raw materials used when one target product is produced, from the production management system 11. The collection unit 51 collects the order unit price of each of the raw materials, the storage unit price of the target product, the storage unit price of each of the raw materials, the disposal unit price of the target product, and the disposal unit price of each of the raw materials, from the production management system 11. The collection unit 51 collects the order quantity of which the raw material has been ordered. The collection unit 51 stores the information of the raw materials used in production of the target product, the current stock quantity of the target product, the current stock quantity of each of the raw materials, the consumed quantity of each of the raw materials used when one target product is produced, in the product information 40. The collection unit 51 stores the order unit price of each of the raw materials, the storage unit price of the target product, the storage unit price of each of the raw materials, the disposal unit price of the target product, and the disposal unit price of each of the raw materials, in the product information 40. The collection unit 51 collects the previous demand quantity of the target product from the production management system 11 and stores the previous demand quantity of the target product in the demand record information 41.

The reception unit 50 causes the lead time designation screen to be displayed in the display unit 32 and receives the lead time for each of the raw materials from ordering the corresponding raw material until the arrival of the corresponding raw material, from the lead time designation screen (S11).

The acquisition unit 60 acquires a predicted demand quantity of the target product for the prediction period (S12). For example, the acquisition unit 60 predicts a demand for the prediction period based on the previous ordered quantity of the target product stored in the demand record information 41, and thus the acquisition unit 60 acquires the predicted demand quantity of the target product.

The calculation unit 61 sets various types of information acquired by the acquisition unit 60, based on various constraint conditions and solves the optimization problem of the objective function represented by the expression (16). Thus, the calculation unit 61 calculates the order quantity of each of the raw materials and the production quantity of the product which cause the cost to be minimized (S13).

The output unit 53 outputs to the display unit 32 the plan display screen on which the order quantity of each of the raw materials and the production quantity of the product calculated by the calculation unit 61 (514). Then, the process is ended.

Achievements

As described above, the plan determination apparatus 10 receives lead time from ordering the raw material until the arrival of the raw material. The plan determination apparatus 10 calculates an order quantity of each of the raw materials and a production quantity of the product which cause the cost relating to manufacturing of the product to be minimized, by using the received lead time for each of the raw materials and a predicted demand quantity of the product. Thus, the plan determination apparatus 10 may determine an order quantity of each raw material and a production quantity of a product so as to obtain high profits. The plan determination apparatus 10 may appropriately perform ordering of a plurality of raw materials which have different lead time or different ordering timings.

The plan determination apparatus 10 calculates the order quantity of each of the raw materials and the production quantity of the product which cause the cost to be minimized, by solving an optimization problem of an objective function in which the order quantity of each of the raw materials and the production quantity of the product are used as input, and the cost relating to manufacturing of the product is used as output. Accordingly, the plan determination apparatus 10 may determine the appropriate order quantity of each of the raw materials and the appropriate production quantity of the product which cause the cost to be minimized.

The objective function outputs a cost which includes some or all of the order cost of each of the raw materials, the production cost for production of the product, the raw material storage cost of each of the raw materials, the product storage cost of the produced product, the raw material disposal cost of each of the raw materials, and the product disposal cost of the product. In this manner, the plan determination apparatus 10 may calculate the order quantity of each of the raw materials and the production quantity of the product which cause all of the above-described types of costs to be reduced so as to be the minimum, by including the considering cost among the order cost, the production cost, the raw material storage cost, the product storage cost, the raw material disposal cost, and the product disposal cost.

The plan determination apparatus 10 determines the production cost depending on the production quantity of the product from the production cost information 43 in which the production cost for each production quantity of the product is stored, assuming that a production line for producing the product is increased when a production upper limit is exceeded respectively. Thus, the plan determination apparatus 10 may calculate the order quantity of each of the raw materials and the production quantity of the product which cause all of the above-described types of costs which also includes the production cost when an additional production line is built, to be reduced so as to be the minimum. Thus, the plan determination apparatus 10 may perform an instruction of the optimum production quantity in accordance with the cost of the raw material or the manufacturing line. The plan determination apparatus 10 may appropriately determine whether an additional manufacturing line is to be built from the cost-wise point of view.

The plan determination apparatus 10 outputs the cost which further includes the deficient product cost depending on a deficient product quantity that is shortage of a stock quantity of the product for a next predicted demand quantity of the product, the stock quantity of the product being calculated based on the production quantity of the product and the predicted demand quantity of the product. Thus, the plan determination apparatus 10 includes an influence by the deficiency as the deficient product cost, and thus may calculate the order quantity of each of the raw materials and the production quantity of the product which cause the cost to be totally reduced so as to be the minimum.

### Embodiment 2

Hitherto, the embodiment for the apparatus in this disclosure is described. However, the technology in this disclosure may be implemented by various different embodiments in addition to the above-described embodiment. Thus, in the following descriptions, other embodiments will be described.

For example, in the above embodiment, a case where the lead time for each of the raw materials of the product from ordering the corresponding raw material until the arrival of the corresponding raw material is received by an input of a user is described, but, it is not limited thereto. For example, when the production management system 11 stores the lead time for each of the raw materials of the product, the lead time may be received by collecting the lead time for each of the raw materials of the product from the production management system 11.

The components of the devices illustrated in the drawings are functional and conceptual, and do not have to be physically configured as illustrated in the drawings. That is, a specific form of distribution and integration of the devices is not limited to the drawings. A configuration may be made by functionally or physically distributing and integrating all or some of the components in a certain unit in accordance with various loads, use circumstances, or the like. For example, the processing units of the reception unit 50, the collection unit 51, the prediction unit 52 (acquisition unit 60 and calculation unit 61), and the output unit 53 may be appropriately integrated. The processing of the processing units may be separated into processing of a plurality of processing units. All or some of the processing functions which are respectively performed in the processing units may be realized by a CPU and a program which is analyzed and executed by the CPU or be realized as hardware by a wired logic.

Plan Determination Program

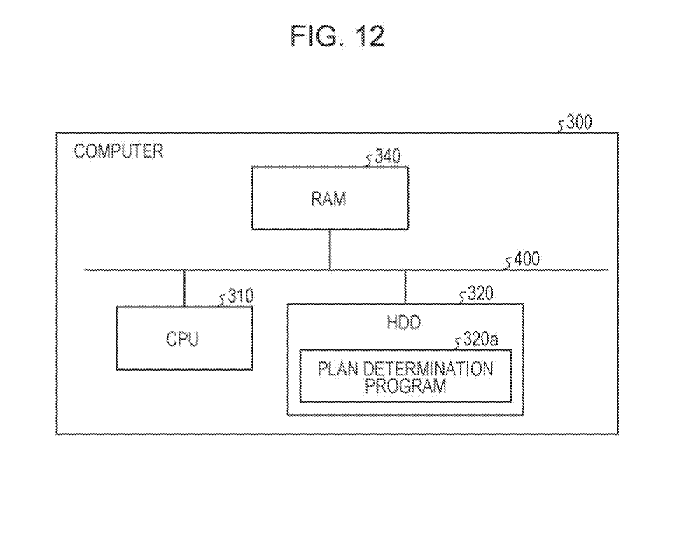

The various types of processing described in the above embodiment may be realized by causing a pre-prepared program to be executed by a personal computer or a computer system such as a workstation. In the following descriptions, an example of the computer system executing a program which has functions similar to those of the above embodiment will be described. FIG. 12 is a diagram illustrating a computer which executes a plan determination program.

As illustrated in FIG. 12, a computer 300 includes a central processing unit (CPU) 310, a hard disk drive (HDD) 320, and a random access memory (RAM) 340. The units 310 to 340 are connected to each other through a bus 400.

In the HDD 320, a plan determination program 320a which performs functions similar to the reception unit 50, the collection unit 51, the prediction unit 52, and the output unit 53 has been stored in advance. The functions of the plan determination program 320a may be appropriately divided.

The HDD 320 stores various types of information. For example, the HDD 320 stores an OS or various types of data used in determination of the order quantity.

Operations similar to those of the processing units in the embodiment are performed by causing the CPU 310 to read the plan determination program 320a from the HDD 320 and to execute the plan determination program 320a. That is, the plan determination program 320a performs operations similar to those of the reception unit 50, the collection unit 51, the prediction unit 52, and the output unit 53.

It is not always necessary that the above-described plan determination program 320a is stored in the HDD 320 from the beginning.

For example, the program is stored in “a portable physical medium” inserted into the computer 300, such as a flexible disk (FD), a CD-ROM, a DVD disc, a magneto-optical disk, and an IC card. Thus, the computer 300 may read the program from the portable physical medium and execute the program.

The program may be stored in “other computer (or server)” or the like which is connected to the computer 300 through a public network, the Internet, a LAN, a WAN, and the like. Thus, the computer 300 may read the program from the other computer (or server) and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A plan determination method of which process is executed by a computer, the process comprising:
receiving lead time for each raw material for a product, the lead time being indicative of time interval between a time at which an order of the each raw material is ordered and a time of arrival of the each raw material; and
calculating an order quantity of the each raw material and a production quantity of the product which cause a cost relating to manufacturing of the product to be minimized, by using the received lead time for the each raw material and a predicted demand quantity of the product.

2. The plan determination method according to claim 1, wherein
in the calculating, the order quantity of the each raw material and the production quantity of the product which cause the cost relating to manufacturing of the product to be minimized are calculated by solving an optimization problem of an objective function, the order quantity of the each raw material and the production quantity of the product being input to the objective function, the cost relating to manufacturing of the product being output from the objective function.

3. The plan determination method according to claim 2, wherein
the objective function outputs a cost which includes some or all of an order cost for ordering of the order quantity of each raw material, a production cost for production of the product, a raw material storage cost for storing of each raw material in stock, a product storage cost for storing of produced product, a raw material disposal cost for disposal of each raw material in stock due to passing of a predetermined material storing period, and a product disposal cost for disposal of a product of which a predetermined product storing period elapses from the production.

4. The plan determination method according to claim 3, wherein
in the calculating, the production cost depending on the production quantity of the product is determined from production cost information storing the production cost for each of the production quantity of the product assuming that a production line for producing the product is increased when a production upper limit is exceeded respectively.

5. The plan determination method according to claim 3, wherein
the objective function outputs the cost which further includes a deficient product cost depending on a deficient product quantity that is shortage of a stock quantity of the product, which is calculated based on the production quantity of the product and the predicted demand quantity of the product, to a next predicted demand quantity of the product.

6. A non-transitory computer-readable recording medium having therein a program for causing a computer to execute a process for a plan determination, the process comprising:
receiving lead time for each raw material for a product, the lead time being indicative of time interval between a time at which an order of the each raw material is ordered and a time of arrival of the each raw material; and
calculating an order quantity of each raw material and a production quantity of the product which cause a cost relating to manufacturing of the product to be minimized, by using the received lead time for each raw material and a predicted demand quantity of the product.

7. A plan determination apparatus comprising:
a reception unit that receives receiving lead time for each raw material for a product, the lead time being indicative of time interval between a time at which an order of the each raw material is ordered and a time of arrival of the each raw material; and
a calculation unit that calculates an order quantity of each raw material and a production quantity of the product which cause a cost relating to manufacturing of the product to be minimized, by using the lead time for each raw material which is received from the reception unit, and a predicted demand quantity of the product.
